(19) United States
(12) Patent Application Publication
(10) Pub. No.: US 2026/0187187 A1
(43) Pub. Date: Jul. 2, 2026

(54) INFORMATION PROCESSING DEVICE, INFORMATION PROCESSING METHOD, AND NON-TRANSITORY COMPUTER READABLE MEDIUM

(71) Applicant: NEC Corporation, Tokyo (JP)

(72) Inventors: Yuzuru OKAJIMA, Tokyo (JP); Yoichi SASAKI, Tokyo (JP)

(73) Assignee: NEC Corporation, Tokyo (JP)

(21) Appl. No.: 19/407,243

(22) Filed: Dec. 3, 2025

(30) Foreign Application Priority Data
Dec. 27, 2024 (JP) 2024-232322

(51) Int. Cl. G06F 17/16

(52) U.S. Cl. CPC G06F 17/16

(57) ABSTRACT

An information processing device includes a single variable term calculation unit for calculating a single variable term that, among a plurality of terms for calculating a similarity with an input vector for each of a plurality of candidate vectors that are candidates for a similar vector similar to the input vector, depends on either one of the candidate vector and the input vector and does not depend on the other one, a first range calculation unit for calculating, for each of the plurality of candidate vectors, a first range that the similarity can take based on the single variable term, a candidate selection unit for selecting one or more candidate vectors from the plurality of candidate vectors based on the first range, and an identification unit for identifying a similar vector from the selected one or more candidate vectors.

### INCORPORATION BY REFERENCE

This application is based upon and claims the benefit of priority from Japanese patent application No. 2024-232322, filed on Dec. 27, 2024, the disclosure of which is incorporated herein in its entirety by reference.

### TECHNICAL FIELD

The present disclosure relates to an information processing device, an information processing method, and a program.

### BACKGROUND ART

JP 2011-85991 A describes a technique of searching a set of searched documents for a feature vector of a searched document similar to a feature vector of a search word. In the technique, similarity between a feature vector of a word and the feature vector of the searched document is calculated in advance, and similarity between the feature vector of the search word and the feature vector of the searched document is calculated by the weighted sum of the similarities calculated in advance for each word constituting the search word.

### SUMMARY

Although the technique described in JP 2011-85991 A reduces calculation cost related to the search, it is premised that an element (e.g., word) that can constitute a query (e.g., search word) is known in advance. Thus, application cannot be made to a case where it is difficult to assume, in advance, an element that can constitute a query. Therefore, in more various cases, a technique for reducing the calculation cost for finding a vector similar to a designated vector is required.

The present disclosure has been made in view of the above aspect, and an exemplary object thereof is to provide a technique for reducing a calculation cost for finding a vector similar to a designated vector.

An information processing device according to an exemplary aspect of the present disclosure includes a single variable term calculation means for calculating a single variable term that, among a plurality of terms for calculating a similarity with an input vector for each of a plurality of candidate vectors that are candidates for a similar vector similar to the input vector, depends on either one of the candidate vector and the input vector and does not depend on the other one, a first range calculation means for calculating, for each of the plurality of candidate vectors, a first range that the similarity can take based on the single variable term, a candidate selection means for selecting one or more candidate vectors from the plurality of candidate vectors based on the first range, and an identification means for identifying the similar vector from the selected one or more candidate vectors.

An information processing method according to an exemplary aspect of the present disclosure includes single variable term calculation processing in which at least one processor calculates a single variable term that, among a plurality of terms for calculating a similarity with an input vector for each of a plurality of candidate vectors that are candidates for a similar vector similar to the input vector, depends on either one of the candidate vector and the input vector and does not depend on the other one, first range calculation processing in which the at least one processor calculates, for each of the plurality of candidate vectors, a first range that the similarity can take based on the single variable term, candidate selection processing in which the at least one processor selects one or more candidate vectors from the plurality of candidate vectors based on the first range, and identification processing in which the at least one processor identifies the similar vector from the selected one or more candidate vectors.

A program according to an exemplary aspect of the present disclosure for causing a computer to function as an information processing device, the program causing the computer to function as a single variable term calculation means for calculating a single variable term that, among a plurality of terms for calculating a similarity with an input vector for each of a plurality of candidate vectors that are candidates for a similar vector similar to the input vector, depends on either one of the candidate vector and the input vector and does not depend on the other one, a first range calculation means for calculating, for each of the plurality of candidate vectors, a first range that the similarity can take based on the single variable term, a candidate selection means for selecting one or more candidate vectors from the plurality of candidate vectors based on the first range, and an identification means for identifying the similar vector from the selected one or more candidate vectors.

According to an exemplary aspect of the present disclosure, there is an exemplary effect that a technique for reducing a calculation cost for finding a vector similar to a designated vector can be provided.

### BRIEF DESCRIPTION OF THE DRAWINGS

FIG. 1 is a block diagram illustrating a configuration of an information processing device according to the present disclosure;

FIG. 2 is a flowchart illustrating a flow of an information processing method according to the present disclosure;

FIG. 3 is a block diagram illustrating a configuration of the information processing device according to the present disclosure;

FIG. 4 is a flowchart illustrating a flow of the information processing method according to the present disclosure;

FIG. 5 is a diagram schematically illustrating narrowing down of a candidate vector according to the present disclosure;

FIG. 6 is a diagram schematically illustrating an example of a marginal contribution degree vector according to the present disclosure; and

FIG. 7 is a block diagram illustrating a hardware configuration of a computer that functions as each of the devices according to the present disclosure.

### EXAMPLE EMBODIMENT

Hereinafter, example embodiments of the present disclosure will be exemplified. However, the present disclosure is not limited to the following exemplary example embodiments, and various modifications can be made within a scope described in the claims. For example, example embodiments obtained by appropriately combining techniques (some or all of products or methods) adopted in the following exemplary example embodiments can also be included in the scope of the present disclosure. Furthermore, example embodiments obtained by appropriately omitting some of the techniques adopted in the following exemplary example embodiments can also be included in the scope of the present disclosure. Effects mentioned in the following exemplary example embodiments are examples of effects expected in the exemplary example embodiments, and do not define the extension of the present disclosure. In other words, example embodiments that do not provide the effects mentioned in the following exemplary example embodiments can also be included in the scope of the present disclosure.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment may also be adopted in another exemplary example embodiment included in the present disclosure with a scope in which no particular technical problem arises. In addition, each technique illustrated in the drawings referred to for describing the present exemplary example embodiment can also be adopted in another exemplary example embodiment included in the present disclosure within a scope in which no particular technical problem arises.

### (Outline of Information Processing Device 1)

An information processing device 1 is a device for identifying a similar vector similar to an input vector from among a plurality of candidate vectors. The similar vector may be a candidate vector that is the most similar to the input vector, but may not necessarily be the most similar candidate vector. For example, the similar vector may be a candidate vector that satisfies a similar condition for considering that the similarity with the input vector is high to some extent. In addition, the number of similar vectors is not limited to one, and a plurality of similar vectors may be identified.

As the similarity, an index (e.g., inner product etc.) indicating being more similar as the value increases may be adopted, or (e.g., Euclidean distance etc.) indicating being more similar as the value decreases may be adopted. In the following, in a case where any index is adopted, being more similar is described as “high similarity”, and being less similar is described as “low similarity”. That is, in a case where the inner product is adopted as the similarity, the similarity is higher the larger the inner product, and the similarity is lower the smaller the inner product. Furthermore, in a case where the Euclidean distance is adopted as the similarity, the similarity is higher the smaller the Euclidean distance, and the similarity is lower the larger the Euclidean distance.

### (Configuration of Information Processing Device 1)

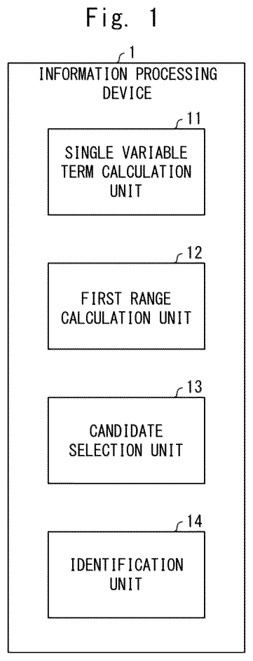

A configuration of the information processing device 1 will be described with reference to FIG. 1. FIG. 1 is a block diagram illustrating the configuration of the information processing device 1. As illustrated in FIG. 1, the information processing device 1 includes a single variable term calculation unit 11, a first range calculation unit 12, a candidate selection unit 13, and an identification unit 14. The single variable term calculation unit 11 is an example of a configuration for achieving a single variable term calculation means. The first range calculation unit 12 is an example of a configuration for achieving a first range calculation means. The candidate selection unit 13 is an example of a configuration for achieving a candidate selection means. The identification unit 14 is an example of a configuration for achieving an identification means.

The single variable term calculation unit 11 calculates a single variable term that depends on, among a plurality of terms for calculating similarity with an input vector for each of a plurality of candidate vectors that are candidates for a similar vector similar to the input vector, either one of the candidate vector and the input vector and does not depend on the other one. Here, the similarity between each candidate vector and the input vector can be calculated using a plurality of terms including a single variable term and a multivariable term. The single variable term is a term that depends on either one of the candidate vector and the input vector and does not depend on the other one. The multivariable term is a term that depends on both the candidate vector and the input vector.

The first range calculation unit 12 calculates, for each of the plurality of candidate vectors, a first range that the similarity can take based on the single variable term. Here, the similarity between each candidate vector and the input vector is calculated using a plurality of terms including a single variable term and a multivariable term as described above. Therefore, in a case where the single variable term is obtained, the first range that the similarity can take can be calculated based on the range that the multivariable term can take. In addition, the range that the multivariable term can take can be calculated based on the single variable term. The first range indicates, for example, a range of similarity defined by an upper bound and a lower bound. The upper bound indicates the highest value that the similarity can take. The lower bound indicates the lowest value that the similarity can take. The first range calculation unit 12 may not calculate both the upper bound and the lower bound for all candidate vectors. For example, only the upper bound may be calculated for some candidate vectors, and only the lower bound may be calculated for other candidate vectors.

The candidate selection unit 13 selects one or more candidate vectors from the plurality of candidate vectors based on the first range. For example, the candidate selection unit 13 may select one or more candidate vectors in which the upper bound of the first range is equal to or greater than a threshold value, the threshold value being a lower bound of the candidate vector in which the lower bound of the first range is the highest among the plurality of candidate vectors. The lower bound used as the threshold value for selection is not limited to the highest lower bound, and may be, for example, a lower bound of any order (e.g., second etc.) counting from the higher side. In addition, the target to be compared with the threshold value is not limited to the upper bound, and may be, for example, a value obtained by adding or subtracting the magnitude of the error estimated for the upper bound to the upper bound. As described above, the first range narrows down the candidates of the similar vector similar to the input vector from the “plurality of candidate vectors” to the “selected one or more candidate vectors”.

The identification unit 14 identifies a similar vector from the selected one or more candidate vectors. For example, the identification unit 14 may identify a similar vector using a known technique of identifying a similar vector similar to the input vector from a plurality of candidate vectors.

### (Effects of Information Processing Device 1)

As described above, the information processing device 1 adopts a configuration including a single variable term calculation unit 11 for calculating, among a plurality of terms for calculating similarity with an input vector for each of a plurality of candidate vectors that are candidates for a similar vector similar to the input vector, a single variable term that depends on either one of the candidate vector and the input vector and does not depend on the other one, a first range calculation unit 12 for calculating a first range that the similarity can take based on the single variable term for each of the plurality of candidate vectors, a candidate selection unit 13 for selecting one or more candidate vectors from the plurality of candidate vectors based on the first range, and an identification unit 14 for identifying the similar vector from the selected one or more candidate vectors.

Here, the calculation cost related to the single variable term can be easily reduced as compared with the calculation cost related to the multivariable term. For example, in a case where a plurality of candidate vectors are known in advance, a single variable term depending on each candidate vector can be calculated in advance. In addition, the calculation cost related to the single variable term that depends on the input vector does not depend on the number of the plurality of candidate vectors. On the other hand, since the calculation cost related to the multivariable term cannot be calculated in advance and depends on the number of the plurality of candidate vectors, it is difficult to reduce the calculation cost. According to the information processing device 1, the candidates of the similar vector can be narrowed down simply by calculating the single variable term without calculating the multivariable term, and thus, it is possible to obtain an effect that the calculation cost for finding a vector similar to the designated vector can be reduced.

### (Flow of Information Processing Method S1)

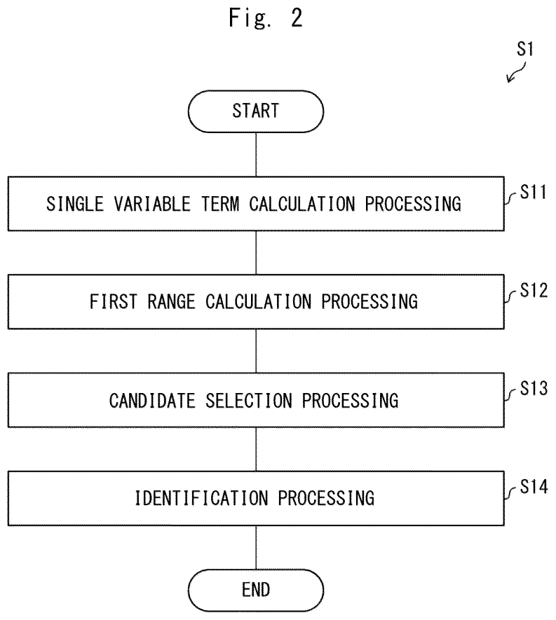

A flow of an information processing method S1 will be described with reference to FIG. 2. FIG. 2 is a flowchart illustrating the flow of the information processing method S1. As illustrated in FIG. 2, the information processing method S1 includes a single variable term calculation processing S11, a first range calculation processing S12, a candidate selection processing S13, and an identification processing S14.

In the single variable term calculation processing S11, at least one processor (e.g., the single variable term calculation unit 11) calculates, among a plurality of terms for calculating the similarity with the input vector for each of a plurality of candidate vectors that are candidates for a similar vector similar to the input vector, a single variable term that depends on either one of the candidate vector and the input vector and does not depend on the other one.

In the first range calculation processing S12, at least one processor (e.g., the first range calculation unit 12) calculates, for each of the plurality of candidate vectors, a first range that the similarity can take based on the single variable term.

In the candidate selection processing S13, at least one processor (e.g., the candidate selection unit 13) selects one or more candidate vectors from the plurality of candidate vectors based on the first range.

In the identification processing S14, at least one processor (e.g., the identification unit 14) identifies a similar vector from the selected one or more candidate vectors.

### (Effects of Information Processing Method S1)

As described above, the information processing method S1 adopts a configuration including a single variable term calculation processing S11 in which at least one processor calculates, among a plurality of terms for calculating similarity with an input vector for each of a plurality of candidate vectors that are candidates for a similar vector similar to the input vector, a single variable term that depends on either one of the candidate vector and the input vector and does not depend on the other one, a first range calculation processing S12 in which at least one processor calculates a first range that the similarity can take based on the single variable term for each of the plurality of candidate vectors, a candidate selection processing S13 in which at least one processor selects one or more candidate vectors from the plurality of candidate vectors based on the first range, and an identification processing S14 in which at least one processor identifies the similar vector from the selected one or more candidate vectors. Therefore, according to the information processing method S1, the same effects as those of the information processing device 1 can be obtained.

### Second Exemplary Example Embodiment

A second exemplary example embodiment that is an example of the example embodiments of the present disclosure will be described in detail with reference to the drawings. Components that have the same functions as the components described in the above-described exemplary example embodiment are denoted by the same reference signs, and the description thereof will be omitted as appropriate. An application range of each technique adopted in the present exemplary example embodiment is not limited to the present exemplary example embodiment. That is, each technique adopted in the present exemplary example embodiment may also be adopted in another exemplary example embodiment included in the present disclosure with a scope in which no particular technical problem arises. Furthermore, each technique illustrated in the drawings referred to for describing the present exemplary example embodiment may also be adopted in another exemplary example embodiment included in the present disclosure within a scope in which no particular technical problem arises.

### (Outline of Information Processing Device 1A)

Similarly to the information processing device 1, an information processing device 1A is a device for identifying a similar vector similar to an input vector from among a plurality of candidate vectors. For example, the processing by the information processing device 1A is expressed as the following formula (1).

$$\begin{matrix}[ Mathematical formula 1 ] & \\ {i}^{*} = arg {max}_{i ∈ \{ i , … , n \}} f ( {v}_{i} , q ) & ( 1 )\end{matrix}$$

In the present specification, for example, “a symbol in which a subscript i is added to v” in formula (1) or the like is expressed as “v_i” or the like in the text. Furthermore, for example, “a symbol in which a superscript * is added to i” is expressed as “i\hat{ }*” or the like in the text. The notation such as “\hat{ }” may indicate a power.

For example, the “square of Q” is expressed as “Q\hat{ }2” or the like. The same applies to symbols including a subscript and a superscript in a formula to be described later. In addition, for example, “μ with a hat” in a formula to be described later is expressed as “\hat{ }μ” or the like in the text.

In formula (1), q represents an input vector. The input vector q is a real value vector having a length d (the number of dimensions). v_i represents a candidate vector that is a candidate for a similar vector similar to the input vector q. i is a subscript for identifying the candidate vector, and is any of 1, 2, . . . , and n. The candidate vector v_i is a real value vector having a length d (the number of dimensions). f is a function that returns the similarity between the input vector q and the candidate vector v_i. i\hat{ }* indicates a subscript of the candidate vector identified as the similar vector.

Formula (1) is an example, and the information processing device 1A is not necessarily limited to having a candidate vector having the highest similarity as a similar vector as in formula (1), and may have a candidate vector having similarity satisfying a predetermined condition as a similar vector. Furthermore, the number of similar vectors identified by the information processing device 1A may be one or plurals.

### (BanditMIPS)

The information processing device 1A performs processing that has improved BanditMIPS. BanditMIPS is an example of a technique for identifying a similar vector similar to an input vector. BanditMIPS is a method in which a multi-armed bandit problem (best arm identification) is applied to the Maximum Inner Product Search (MIPS) problem. In BanditMIPS, an inner product (an example of similarity) of an input vector and a candidate vector is regarded as an expected value of a product of random variables. As a result, it is possible to apply the multi-armed bandit problem of selecting the arm having the maximum expected value of the reward to the problem of finding the candidate vector having a high similarity.

The plurality of candidate vectors correspond to the plurality of arms.

For example, in a case where an inner product is adopted as the similarity, the similarity can be expressed by an expected value of a random variable as shown in the following formula (2).

$$\begin{matrix}[ Mathematical formula 2 ] & \\ {μ}_{i} := \frac{1}{d} {q}^{T} {v}_{i} = \frac{1}{d} {\sum }_{j = 1}^{d} {q}_{j} {v}_{ij} = E [ {QV}_{i} ] & ( 2 )\end{matrix}$$

In formula (2), u_i represents a normalized inner product of the input vector q and the candidate vector v_i. The normalized inner product indicates that obtained by dividing an inner product by the number of dimensions d. Q represents a random variable having q_j, that is the j^{th} element of the input vector q, as a value. V_i represents a random variable having v_j, that is the j^{th} element of the candidate vector v_i, as a value. E represents an expected value. As shown in formula (2), the normalized inner product μ_i and the expected value E[QV_i] of the product of the random variable Q and the V_i can both be calculated by obtaining the product of the elements corresponding to the same subscript j, and thus can be regarded as equal. That is, the problem of finding the candidate vector v_i with a larger inner product μ_i as the similarity can be regarded as equal to the multi-armed bandit problem of finding i with a larger expected value E[QV_i]. At this time, n candidate vectors v_i correspond to n arms in the multi-armed bandit problem. Pulling the i^{th} arm once corresponds to observing the value of QV_i once. An object is to find i in which a value of the observed QV_i is a reward and an expected value E[QV_i] of the reward is large.

In BanditMIPS, a range (confidence interval of expected value of reward) the similarity between each candidate vector and the input vector can take is calculated by sampling elements from each candidate vector included in a candidate list S. Furthermore, one or more candidate vectors are selected from the candidate list S based on the calculated range, and the candidate list S is updated by excluding vectors other than the selected candidate vector. Next, a range the similarity between each candidate vector and the input vector can take is updated by sampling new elements from each candidate vector and the input vector included in the updated candidate list S. One or more candidate vectors are selected from the candidate list S based on the updated range, and the candidate list S is updated by excluding vectors other than the selected one or more candidate vectors. In this way, the update of the candidate list S is repeated while newly sampling the element, and if the number of candidate vectors included in the candidate list S becomes equal to or less than a threshold value (e.g., one), the candidate vector is identified as the similar vector.

In BanditMIPS, it is assumed that the inner product follows the sub-Gaussian distribution.

In order to operate BanditMIPS, it is necessary to designate the parameters σ and δ. The parameter σ is a parameter representing the magnitude of the fluctuation in the Sub-Gaussian distribution and corresponds to the standard deviation in the normal distribution. The parameter δ indicates the upper limit of the probability of failure to find the vector with the largest inner product, where the smaller the parameter, the more reliable the result but greater the number of trials.

### (Problem of BanditMIPS)

BanditMIPS has a problem that it requires a large amount of samples (sampled elements) before a range (confidence interval of the expected value of the reward) in which the similarity between each candidate vector and the input vector can take can be calculated, and thus takes time to search. The main reason a large amount of sample is required is that the magnitude of the inner product is not known unless the number of samples becomes equal to or greater than a certain level. In other words, in a case where the number of samples is small, an effective range to an extent that the candidate list S can be narrowed down cannot be obtained. The information processing device 1A is an aspect for solving the problem of BanditMIPS, and can effectively narrow down candidate vectors without requiring a large amount of samples. As a result, the information processing device 1A reduces the calculation cost related to identifying a similar vector similar to the input vector.

### (Configuration of Information Processing Device 1A)

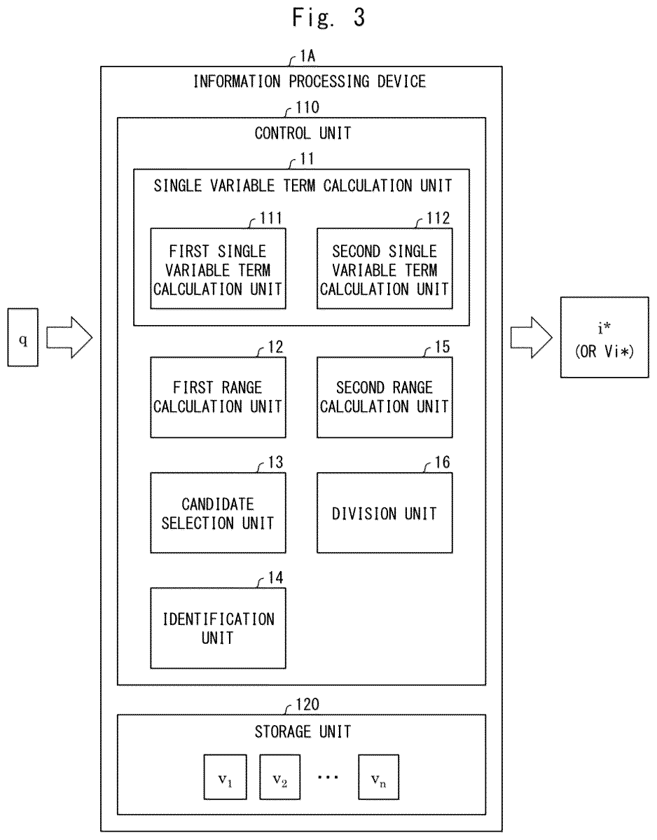

Next, a configuration of the information processing device 1A will be described with reference to FIG. 3. FIG. 3 is a block diagram illustrating the configuration of the information processing device 1A. As illustrated in FIG. 3, in a case where the input vector (q) is input, the information processing device 1A outputs a similar vector (v_i\hat{ }*) or an identifier (i\hat{ }*) of the similar vector. Furthermore, the information processing device 1A includes a control unit 110 and a storage unit 120. The control unit 110 integrally controls each unit of the information processing device 1A. The storage unit 120 stores various data and programs used by the control unit 110.

Furthermore, the information processing device 1A may incorporate an input unit, an output unit, and a communication unit (not illustrated), or may be connected to peripheral devices functioning as these units. The input unit may be configured by, for example, a mouse, a keyboard, a touch panel, a microphone, or the like, but is not limited thereto. The output unit may be configured by, for example, a display, a touch panel, a speaker, or the like, but is not limited thereto. The communication unit may be configured by, for example, a network interface, but is not limited thereto.

The control unit 110 includes a second range calculation unit 15 and a division unit 16 in addition to the single variable term calculation unit 11, the first range calculation unit 12, the candidate selection unit 13, and the identification unit 14 included in the information processing device 1. The second range calculation unit 15 is an example of a configuration that implements a second range calculation means. The division unit 16 is an example of a configuration that implements a division means. The storage unit 120 stores the candidate vector v_i. The candidate vector v_i may be stored in an external device communicably connected to the information processing device 1 instead of or in addition to being stored in the storage unit 120.

### (Single Variable Term Calculation Unit 11)

The single variable term calculation unit 11 is configured as follows in addition to being configured similarly to that in the first exemplary example embodiment. The single variable term calculation unit 11 includes a first single variable term calculation unit 111 and a second single variable term calculation unit 112.

The first single variable term calculation unit 111 calculates in advance a first single variable term that depends on each candidate vector and does not depend on the input vector among the single variable terms. For example, examples of the first single variable term include an expected value, variance, or the like of the random variable (or a power of the random variable) that can be calculated by regarding an element of the candidate vector as the random variable. In addition, the first single variable term may be a term obtained by performing a predetermined calculation (e.g., constant multiplication, etc.) using one or both of the expected value and the variance. However, the first single variable term is not limited to the example described above. The second single variable term calculation unit 112 calculates a second single variable term that depends on the input vector and does not depend on each candidate vector among the single variable terms according to the input of the input vector. For example, examples of the second single variable term include an expected value, variance, or the like of the random variable (or a power of the random variable) that can be calculated by regarding an element of the input vector as the random variable. In addition, the second single variable term may be a term obtained by performing a predetermined calculation (e.g., constant multiplication, etc.) using one or both of the expected value and the variance. However, the second single variable term is not limited to the example described above.

Here, the expected value E[QV_i] indicated to be equal to the example of the similarity in formula (2) can be decomposed into a plurality of terms including a single variable term and a multivariable term as shown in the following formula (3).

$$\begin{matrix}[ Mathematical formula 3 ] & \\ \begin{matrix}E [ {QV}_{i} ] = \frac{1}{2} ( E [ {Q}^{2} ] + E [ {V}_{i}^{2} ] - E [ {( Q - {V}_{i} )}^{2} D \\ = \frac{1}{2} ( {\underbrace{E [ {Q}^{2} ] + E [ {V}_{i}^{2} ] - {( E [ Q ] - E [ {V}_{i} ] )}^{2}}}_{Single variable term} - {\underbrace{Var [ Q - {V}_{i} ]}}_{Multivariable term} )\end{matrix} & ( 3 )\end{matrix}$$

The decomposition of formula (3) is based on the following formulas (4) and (5).

$$\begin{matrix}[ Mathematical formula 4 ] & \\ \begin{matrix}E [ {( Q - {V}_{i} )}^{2} ] = E [ {Q}^{2} - 2 {QV}_{i} + {V}_{i}^{2} ] \\ = E [ {Q}^{2} ] + E [ {V}_{i}^{2} ] - 2 E [ {QV}_{i} ]\end{matrix} & ( 4 )\end{matrix}$$

$$\begin{matrix}[ Mathematical formula 5 ] & \\ \begin{matrix}{E [ {( Q - {V}_{i} )}^{2} ] = E ( Q - {V}_{i} ] )}^{2} + Var [ Q - {V}_{i} ] \\ = {( E [ Q ] - E [ {V}_{i} ] )}^{2} + Var [ Q - {V}_{i} ]\end{matrix} & ( 5 )\end{matrix}$$

In formula (3), Var represents variance. Var[Q−V_i] is an example of a multivariable term that depends on both the input vector q and the candidate vector v_i. In addition, each of E[Q\hat{ }2], E[V_i\hat{ }2], E[Q], and E[V_i] is an example of a single variable term that depends on either one of the input vector q and the candidate vector v_i and does not depend on the other one.

Among these single variable terms, the single variable terms E[V_i\hat{ }2] and E[V_i] are examples of the first single variable term that depends on the candidate vector v_i and does not depend on the input vector q. The first single variable term calculation unit 111 calculates these first single variable terms in advance for each candidate vector v_i stored in the storage unit 120, and stores the first single variable terms in the storage unit 120. In addition, the first single variable term calculation unit 111 calculates a first single variable term Var[V_i] (details will be described later) for calculating the first range in advance for each candidate vector v_i, and stores the first single variable term Var[V_i] in the storage unit 120. Since the first single variable term can be commonly used for any input vector, it merely needs to be calculated once in advance, which contributes to a reduction in calculation cost.

Among these single variable terms, the single variable terms E[Q\hat{ }2] and E[Q] are examples of the second single variable term that depends on the input vector q and does not depend on the candidate vector v_i. The second single variable term calculation unit 112 calculates these second single variable terms according to the input of the input vector q, and stores the second single variable terms in the storage unit 120. In addition, the second single variable term calculation unit 112 calculates a second single variable term Var[Q] (details will be described later) for calculating the first range according to the input of the input vector q, and stores the second single variable term Var[Q] in the storage unit 120. The second single variable term merely needs to be calculated once according to the input of the input vector, and the calculation cost does not depend on the number of candidate vectors. Therefore, the calculation of the second single variable term according to the input of the input vector contributes to the reduction of the calculation cost.

The similarity is not limited to the inner product. For example, even in a case where the Euclidean distance is adopted as the similarity, the Euclidean distance can be decomposed into a plurality of terms including a single variable term and a multivariable term, for example, as shown in the following formula (6).

$$\begin{matrix}[ Mathematical formula 6 ] & \\ E [ {( Q - {V}_{i} )}^{2} ] = {\underbrace{{( E [ Q ] - E [ {V}_{i} ] )}^{2}}}_{Single variable term} + {\underbrace{Var [ Q - {V}_{i} ]}}_{Multivariable term} & ( 6 )\end{matrix}$$

In formula (6), Var[Q−V_i] is an example of a multivariable term that depends on both the input vector q and the candidate vector v_i. In addition, each of E[Q] and E[V_i] is an example of a single variable term that depends on either one of the input vector q and the candidate vector v_i and does not depend on the other one. Among these single variable terms, E[V_i] is an example of the first single variable term, and is calculated in advance by the first single variable term calculation unit 111 and stored in the storage unit 120.

Furthermore, E[Q] is an example of the second single variable term, and is calculated by the second single variable term calculation unit 112 according to the input of the input vector q and stored in the storage unit 120. As described above, the information processing device 1A can operate even in a case where either the inner product or the Euclidean distance is adopted as the similarity, but the following description will be given mainly for an example in which the inner product is adopted as the similarity.

In addition, in a case where the input vector and each candidate vector are divided into a plurality of groups by the division unit 16 to be described later, the single variable term calculation unit 11 calculates the single variable term for each group of each candidate vector and each group of input vectors.

For example, the first single variable term calculation unit 111 calculates the first single variable term in advance for each group of each candidate vector. The first single variable term for each group of each candidate vector is similarly described by replacing the “candidate vector” in the description related to the first single variable term with a “candidate partial vector” including elements included in the group.

In addition, for example, the second single variable term calculation unit 112 calculates the second single variable term for each group of input vectors. The second single variable term for each group of input vectors is similarly described by replacing the “input vector” in the description related to the second single variable term with an “input partial vector” including elements included in the group.

### (First Range Calculation Unit 12)

The first range calculation unit 12 is configured as follows in addition to being configured similar to that in the first exemplary example embodiment. For each of the plurality of candidate vectors, the first range calculation unit 12 calculates the first range by calculating the range the multivariable term can take based on the single variable term. For example, the range that can be taken by the multivariable term Var[Q−V_i] in formula (3) can be calculated using the following formula (7) based on the single variable terms Var[Q] and Var[V_i].

$$\begin{matrix}[ Mathematical formula 7 ] & \\ 0 \leq Var [ Q - {V}_{i} ] \leq 2 ( Var [ Q ] + Var [ {V}_{i} ] ) & ( 7 )\end{matrix}$$

In formula (7), Var[Q] is the second single variable term, and is calculated by the second single variable term calculation unit 112 according to the input of the input vector q as described above. Var[V_i] is the first single variable term, and is calculated in advance for the candidate vector v_i by the first single variable term calculation unit 111 as described above. Here, formula (7) is proved as follows.

$$\begin{matrix}[ Mathematical formula 8 ] & \\ Var [ Q - {V}_{i} ] = Var [ Q ] + Var [ {V}_{i} ] - 2 Cov ( Q , {V}_{i} ) \geq 0 & ( 8 )\end{matrix}$$

$$\begin{matrix}[ Mathematical formula 9 ] & \\ Var [ Q ] + Var [ {V}_{i} ] \geq 2 \vert Cov ( Q , {V}_{i} ) \vert & ( 9 )\end{matrix}$$

Since formula (8) holds, formula (9) is established. Therefore, formula (7) is derived.

As described above, the first range of the expected value E[QV_i] (i.e., equivalent to an example of similarity) is calculated by applying the range that can be taken by the multivariable term shown in formula (7) to the above-described formula (3) obtained by decomposing the expected value E[QV_i] into the single variable term and the multivariable term. The first range that can be calculated in this way is obtained without requiring a large amount of sample. Therefore, the calculation cost for narrowing down the candidate vectors can be reduced.

In addition, in a case where the input vector and each candidate vector are divided into a plurality of groups by the division unit 16 to be described later, the first range calculation unit calculates the first range based on the single variable term for each group of each candidate vector. For example, the first range for each group is similarly described by replacing the input vector and the candidate vector with the input partial vector and the candidate partial vector in the description of the first range described above.

### (Candidate Selection Unit 13)

The candidate selection unit 13 is configured as follows in addition to being configured similar to that in the first exemplary example embodiment. The candidate selection unit 13 selects one or more candidate vectors from the plurality of candidate vectors based on the second range. Here, the second range is a range that can be taken by the similarity calculated based on at least some of the multivariable terms and the first range, and will be described in detail later. In other words, since the second range is calculated based on the first range, selecting one or more candidate vectors based on the second range is an example of selecting based on the first range. Here, the first range calculated by the single variable term and the second range calculated by further considering the multivariable term in addition to the first range can be different. Since new information derived from the multivariable term is added in addition to the information derived from the first range, the second range can be narrower than the first range.

For example, the candidate selection unit 13 may select one or more candidate vectors in which the upper bound of the second range is equal to or greater than a threshold value, the threshold value being a lower bound of the candidate vector in which the lower bound of the second range is the highest among the plurality of candidate vectors. The lower bound used as the threshold value for selection and variations to be compared with the threshold value are similar to those of the candidate selection unit 13 of the first exemplary example embodiment, and thus detailed description will not be repeated.

In this manner, the candidates of the similar vector similar to the input vector are narrowed down from the “plurality of candidate vectors” to the “selected one or more candidate vectors” based on the second range. Hereinafter, the “plurality of candidate vectors” are also referred to as a candidate list. The candidate selection unit 13 updates the candidate list by excluding the candidate vectors that has not been selected from the candidate list. That is, the “selected one or more candidate vectors” correspond to the candidate list after the update. Since the second range is also updated in a case where the candidate list is updated, the candidate selection unit 13 repeats updating the candidate list based on the updated second range.

In a case where the input vector and each candidate vector are divided into a plurality of groups by the division unit 16 to be described later, the candidate selection unit 13 selects one or more candidate vectors from the plurality of candidate vectors based on the first range for each group of each candidate vector. More specifically, for example, the candidate selection unit 13 may select the one or more candidate vectors based on the second range of each group of each candidate vector. Here, although details will be described later, the second range of each group of each candidate vector is calculated based on the first range of the group of the candidate vectors and at least some multivariable terms. Therefore, selecting one or more candidate vectors from the plurality of candidate vectors based on the second range for each group of each candidate vector is an example of selecting based on the first range for each group of each candidate vector.

### (Identification Unit 14)

The identification unit 14 is configured as follows in addition to being configured similar to that in the first exemplary example embodiment. In a case where one or more candidate vectors (i.e., the number of candidate vectors included in the candidate list) selected by the candidate selection unit 13 become equal to or less than a threshold value, the identification unit 14 identifies the one or more candidate vectors as similar vectors. If the threshold value is one, one similar vector can be identified, and if the threshold is two or more, a plurality of similar vectors can be identified.

### (Second Range Calculation Unit 15)

The second range calculation unit 15 calculates, for each of the plurality of candidate vectors, at least some of the multivariable terms that depends on both the candidate vector and the input vector among the plurality of terms described above, and calculates a second range that the similarity can take based on the at least some of the multivariable terms and the first range.

For example, for each of the plurality of candidate vectors, the second range calculation unit 15 calculates the second range by calculating at least some of the multivariable terms based on elements sampled from the candidate vector and the input vector. For example, the second range calculation unit 15 may calculate the second range based on at least some of the multivariable terms calculated based on the sampled element and the first range. As a result, the candidate selection unit 13 selects one or more candidate vectors from the plurality of candidate vectors based on the second range, and updates the candidate list. Therefore, for each of the selected one or more candidate vectors (i.e., each candidate vector included in the updated candidate list), the second range calculation unit 15 updates the second range by updating at least some of the multivariable terms further based on elements newly sampled from the candidate vector and the input vector. As a result, it can be expected that a range narrower than the previously obtained range is calculated as the second range as the number of samples of the element increases.

Here, as an example of the “method of calculating the second range based on at least some of the multivariable terms and the first range”, for example, there is a method of “calculating a third range based on at least some of the multivariable terms and setting an overlapping portion of the first range and the third range as a second range”. For example, the second range calculation unit 15 may set a lower one of the upper bound of the first range and the upper bound of the third range as the upper bound of the second range, and may set a higher one of the lower bound of the first range and the lower bound of the third range as the lower bound of the second range.

A known technique may be applied to the processing of calculating the third range based on at least some of the multivariable terms, and as an example, a case of applying a method of sampling elements similarly to BanditMIPS will be continuously described.

For example, for each of the plurality of candidate vectors, the second range calculation unit 15 may calculate the third range by calculating at least some of the multivariable terms based on elements sampled from the candidate vector and the input vector. As a result, the second range in which the first range and the third range overlap may be calculated. One or more candidate vectors are selected from the plurality of candidate vectors based on the second range, and the candidate list is updated. Therefore, for each of the selected one or more candidate vectors (i.e., each candidate vector included in the updated candidate list), the second range calculation unit 15 may update the third range by updating at least some of the multivariable terms further based on elements newly sampled from the candidate vector and the input vector. As a result, it can be expected that a range narrower than the previously obtained range is calculated as the third range as the number of samples of the element increases.

As described above, it can be expected that the third range becomes highly accurate as the number of times of sampling increases, but there is a high possibility that the third range is not narrow enough to be effective for narrowing down the candidate vector unless a number of times of sampling of a certain level is performed. On the other hand, the first range that can be calculated in advance can be expected to be narrow enough to be effective for narrowing down the candidate vector. Therefore, the first range is adopted as the second range at the early stage at which the number of times of sampling is small, and there is a high possibility that the third range is reflected on the second range as the number of times of sampling increases. Therefore, by updating the candidate list using the second range in which the first range and the third range overlap, it is possible to narrow down the candidate vector with high accuracy as the number of times of sampling increases while effectively narrowing down the candidate vector from the early stage at which the number of times of sampling is small.

In addition, the method of calculating the third range separately from the first range and calculating the second range from the first range and the third range has been described above, but the present disclosure is not limited to this method. For example, the second range calculation unit 15 may directly calculate the second range based on the sampled element and the first range without calculating the third range. For example, a prior distribution considering the first range may be set, a posterior distribution may be calculated based on Bayesian estimation using the sampled element as an observation value, and the second range may be calculated from the posterior distribution. Specifically, the following method can be used. Assume the multivariable term to be estimated is Var[Q−V_i]. Based on the first range, a prior distribution (e.g., a scaled beta distribution) indicating a range of values the multivariable term can take is set. Then, in a case where a random variable representing a value sampled from the input vector is denoted by Q and a random variable representing a value sampled from the candidate vector is denoted by V_i, a probability distribution (e.g., normal distribution) that Q−V_i follows is set, and a variance of the probability distribution is assumed to follow the prior distribution. A new posterior distribution is calculated based on Bayesian estimation using the sampled element as an observation value. In a case where the posterior distribution cannot be obtained analytically, the posterior distribution may be approximately calculated using a method such as variational Bayes. From the posterior distribution thus calculated, a confidence interval that is a range of values Var[Q−V_i] can take is obtained, and the second range is calculated from the confidence interval. According to this method, the second range can be directly calculated based on the sampled element and the first range without calculating the third range.

In a case where the input vector and each candidate vector are divided into a plurality of groups by the division unit 16 to be described later, the second range calculation unit 15 may calculate the second range for each group of each candidate vector. Here, the second range for each group of each candidate vector can be calculated, for example, by calculating at least some of the multivariable terms for the group of the candidate vectors and being based on the at least some of the multivariable terms and the first range calculated for the group of the candidate vectors. In addition, the second range calculation unit 15 may calculate the second range for the candidate vector by integrating the second ranges calculated for each group of the candidate vectors. In a case where the second ranges of the groups are integrated, each group may be weighted.

In a case where the input vector and each candidate vector are divided into a plurality of groups, the first range and the third range of each group may be integrated instead of integrating the second ranges of each group to obtain the second range of the candidate vector. In this case, a range in which the first range of the candidate vector in which the first ranges of the groups are integrated overlaps with the third range of the candidate vector in which the third ranges of the groups are integrated may be calculated as the second range of the candidate vector.

### (Division Unit 16)

The division unit 16 divides the elements of each candidate vector and the elements of the input vector into a plurality of groups. For example, if the distribution differs depending on the elements in the input vector and the candidate vector, it is conceivable to divide the elements into a plurality of groups with elements having a similar distribution as one group. Since the elements included in each group have a similar distribution, a narrower first range can be obtained for each group. As a result, the candidate vector can be further effectively narrowed down.

In addition, for example, the single variable term calculation unit 11 may divide the elements of each candidate vector and the elements of the input vector into a plurality of groups based on the division information designating the division of the group. The division information may include information designating the number of groups and the size of each group, and is expressed by, for example, the following formula (10).

$$\begin{matrix}[ Mathematical formula 10 ] & \\ {d}^{Group} = [ {d}_{1} , {d}_{2} , … , {d}_{G} ] & ( 10 )\end{matrix}$$

However, the following formula (11) needs to be satisfied.

$$[ Mathematical formula 11 ]$$

$$d = {\sum }_{g = 1}^{G} {d}_{g} \qquad ( 11 )$$

d\hat{ }Group in formula (10) is an example of the division information, and is represented by a vector having a size d_g (g is any of 1, 2, . . . , and G) of each group as an element. G, that is the number of elements, indicates the number of groups. For example, an example in which the number of dimensions d of the input vector and the candidate vector is 12 and d\hat{ }Group=[4, 4, 4] will be described. 4+4+4=12, which satisfies formula (11). In this example, the input vector and the candidate vector are divided into three groups 1 to 3. Group 1 includes first to fourth elements. Group 2 includes fifth to eighth elements. The group 3 includes ninth to twelfth elements. The number of divisions of the group and the number of elements of each group are not limited to the examples described above. For example, the number of each of the groups may not be the same.

### (Flow of Information Processing Method S1A)

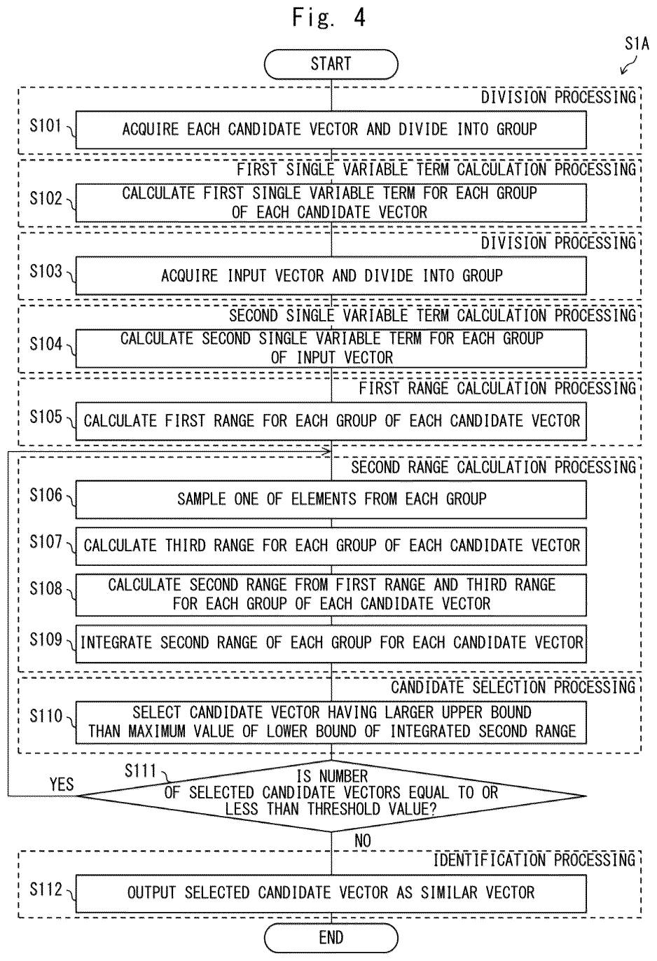

The information processing device 1A configured as described above executes the information processing method S1A. In the description of the information processing method S1A, it is assumed that the input vector and each candidate vector are divided into a plurality of groups, but the division may not necessarily be performed. The case where the division is not performed is similarly described by regarding that the number of groups is one. An example in which the first range and the third range are used to calculate the second range will be described below. FIG. 4 is a flowchart illustrating a flow of the information processing method S1A. As illustrated in FIG. 4, the information processing method S1A includes steps S101 to S112.

Step S101 is an example of the division processing. In step S101, the division unit 16 acquires a plurality of candidate vectors from the storage unit 120, and divides the elements of each candidate vector into a plurality of groups based on the division information. For example, the division is performed based on the division information as shown in formula (10).

Step S102 is an example of the first single variable term calculation processing. In step S102, the first single variable term calculation unit 111 calculates a first single variable term for each group of each candidate vector. For example, if the first single variable term shown in formula (3) is applied to each group g (g=1, 2, . . . , G), it is expressed as E[V_(i, g)\hat{ }2] and E[V_(i, g)]. In addition, if the first single variable term shown in formula (7) is applied to each group g, it is expressed as Var[V_(i, g)]. These first single variable terms are calculated and stored in the storage unit 120.

Steps S101 to S102 may be executed at least once in advance for each candidate vector stored in the storage unit 120, and may not be executed each time the input vector is acquired in the next step S103.

Step S103 is an example of the division processing. In step S103, the division unit 16 acquires the input vector that has been input, and divides the elements of the input vector into a plurality of groups based on the division information. The division information referred to for dividing the input vector is the same as the division information referred to for dividing the candidate vector.

Step S104 is an example of the second single variable term calculation processing. In step S104, the second single variable term calculation unit 112 calculates the second single variable term for each group of the input vectors. For example, if the second single variable term shown in formula (3) is applied to each group g (g=1, 2, . . . , G), it is expressed as E[Q_g\hat{ }2] and E[Q_g]. In addition, if the second single variable term shown in formula (7) is applied to each group g, it is expressed as Var[Q_g]. These second single variable terms are calculated and stored in the storage unit 120.

Step S105 is an example of the first range calculation processing. In step S105, the first range calculation unit 12 calculates a first range for each group of each candidate vector. For example, the upper bound of the first range is calculated by the following formula (12) based on formulas (3) and (7) described above.

$$[ Mathematical formula 12 ]$$

$${u}_{i , g}^{Uni} := \frac{1}{2} ( E [ {Q}_{g}^{2} ] + E [ {V}_{i , g}^{2} ] - {( E [ {Q}_{g} ] - E [ {V}_{i , g}^{2} ] )}^{2} ) \qquad ( 12 )$$

In formula (12), u_(i, g)\hat{ }Uni represents an upper bound of the first range regarding the group g of the candidate vectors v_i. E[V_(i, g)\hat{ }2] and E[V_(i, g)] on the right side are the first single variable terms calculated in step S102. Furthermore, E[Q_g\hat{ }2] and E[Q_g] on the right side are the second single variable terms calculated in step S104.

Furthermore, for example, the lower bound of the first range is calculated by the following formula (13) based on the above-described formulas (3), (7), and (12).

$$[ Mathematical formula 13 ]$$

$${l}_{i , g}^{Uni} := {u}_{i , g}^{Uni} - ( Var [ {Q}_{g} ] + Var [ {V}_{i , g} ] ) \qquad ( 13 )$$

In formula (13), 1_(i, g)\hat{ }Uni represents a lower bound of the first range regarding the group g of the candidate vector v_i. Var[V_(i, g)] on the right side is the first single variable term calculated in step S102. Var[Q_g] on the right side is the second single variable term calculated in step S104.

The calculation of the first range is not limited to formulas (12) to (13), and may be performed based on other formulas.

Furthermore, in step S105, an expected value e_(i, g) of a difference with the corresponding group of the input vector is further calculated for each group g of each candidate vector v_i. Here, e_(i, g): =E[Q_g−V_(i, g)]=E[Q_g]−E[V_(i, g)]. As described above, the expected value of the difference in the variables can be calculated by taking the difference between the expected values of the respective variables. This is because linearity is established for the expected value. That is, the expected value e_(i, g) of the difference can be calculated from the single variable term. On the other hand, since the variance Var[Q_g−V_(i, g)] cannot be decomposed into the form of the sum of the single variable terms unless the variables are independent, estimation using sampling is required.

Steps S103 to S105 may be executed at least once in accordance with the acquisition of the input vector, and do not need to be executed every time the repetitive processing in steps S106 to S111 described later is performed.

Steps S106 to S109 are an example of the second range calculation processing. In step S106, the second range calculation unit 15 samples the elements one by one from each group of the input vector and each candidate vector. Sampling is performed by random selection. However, elements having the same element number are selected in the same group of the input vector and each candidate vector. In other words, an element number is randomly selected from each group, and an element of the selected element number is sampled from the group of the input vector and each candidate vector.

In step S107, the second range calculation unit 15 calculates at least some of the multivariable terms for each group of each candidate vector, and calculates the third range based on the at least some of the multivariable terms. For example, the calculation of the third range is expressed by the following formulas (14) to (20).

$$[ Mathematical formula 14 ]$$

$$r ← \frac{1}{2} {( ( {q}^{′} - {v}^{′} ) - {e}_{i , g} )}^{2} \qquad ( 14 )$$

In formula (14), q′ indicates the j^{th} element sampled in the group g of the input vector q. v′ indicates the j^{th} element sampled in the group g of the candidate vector v_i. e_(i, g) is the expected value of the similarity calculated in step S105.

Here, formula (14) indicates a value r obtained by sampling the elements j belonging to the group g in the multivariable term shown in the following formula (15).

$$[ Mathematical formula 15 ]$$

$$\frac{1}{2} Var [ Q \to {V}_{i} ] \qquad ( 15 )$$

Here, since the value shown in formula (15) is a variance, it can be expressed by using a sum as shown in the following formula (16).

$$[ Mathematical formula 16 ]$$

$$\frac{1}{2} Var [ Q \to {V}_{i} ] = \frac{1}{2} {\sum }_{i} {( ( Q - {V}_{i} ) - E [ Q \to {V}_{i} ] )}^{2} \qquad ( 16 )$$

That is, it can be seen that the above-described formula (14) is obtained by sampling the value shown in the following formula (15). The following formula (17) is calculated using r obtained by sampling in this manner.

$$[ Mathematical formula 17 ]$$

$${\hat{μ}}_{i , g} ← \frac{{d}_{used} {\hat{μ}}_{i} + r}{{d}_{used} + 1} \qquad ( 17 )$$

\hat{ }μ_(i, j) shown in formula (17) indicates a sample average of the similarity (expected value of reward) between the group g of the candidate vector v_i and the group g of the input vector q, and 0 is set as an initial value. Furthermore, d_used is a counter indicating the number of times of sampling, and 0 is set as an initial value. That is, in a case where step S107 is executed for the first time, \hat{ }μ_(i, j) on the right side is 0, and d_used is 0. As shown in formula (17), the sample average of the similarity (expected value of reward) is updated based on the sample average of the similarity (expected value of reward) calculated based on the elements q′ and v′ sampled up to the previous time and r calculated based on the elements q′ and v′ sampled this time. In addition, a confidence interval of the similarity (expected value of reward) is calculated by the following formula (18).

$$[ Mathematical formula 18 ]$$

$$C ← σ \sqrt{\frac{2 log ( 4 {nd}_{used}^{2} / σ )}{{d}_{used} + 1}} \qquad ( 18 )$$

C shown in formula (18) indicates a confidence interval of the similarity (expected value of reward). Formula (18) assumes that the inner product, that is an example of the similarity, follows the sub-Gaussian distribution, and parameter σ is used. The confidence interval C becomes smaller as the number of times of sampling d_used increases. The third range is calculated by the following formulas (19) to (20) using the sample average \hat{ }μ_(i, j) and the confidence interval C calculated in this manner.

$$[ Mathematical formula 19 ]$$

$${u}_{i , g}^{Sample} ← {u}_{i , g}^{Uni} - {\hat{μ}}_{i , g} + C \qquad ( 19 )$$

In formula (19), u_(i, g)\hat{ }Sample represents an upper bound of the third range regarding the group g of the candidate vectors v_i.

$$[ Mathematical formula 20 ]$$

$${l}_{i , g}^{Sample} ← {u}_{i , g}^{Uni} - {\hat{μ}}_{i , g} + C \qquad ( 20 )$$

In formula (20), 1_(i, g)\hat{ }Sample represents the lower bound of the third range regarding the group g of the candidate vectors v_i.

The calculation of the third range is not limited to formulas (14) to (20), and may be performed based on other formulas.

In step S108, the second range calculation unit 15 identifies, for each group of each candidate vector, a second range in which the first range and the third range overlap. For example, the identification of the second range is expressed by the following formulas (21) to (22).

$$[ Mathematical formula 21 ]$$

$${u}_{i , g}^{Group} ← min ( {u}_{i , g}^{Uni} , {u}_{i , g}^{Sample} ) \qquad ( 21 )$$

In formula (21), u_(i, g)\hat{ }Group represents the upper bound of the second range, and a lower one of the upper bound u_(i, g)\hat{ }Uni of the first range and the upper bound u_(i, g)\hat{ }Sample of the third range is applied.

$$[ Mathematical formula 22 ]$$

$${l}_{i , g}^{Group} ← max ( {l}_{i , g}^{Uni} , {l}_{i , g}^{Sample} ) \qquad ( 22 )$$

In formula (22), 1_(i, g)\hat{ }Group represents the lower bound of the second range, and a higher one of the lower bound 1_(i, g)\hat{ }Uni of the first range and the lower bound 1_(i, g)\hat{ }Sample of the third range is applied.

The calculation of the second range based on the first range and the third range is not limited to formulas (21) to (22), and may be performed based on other formulas.

In step S109, the second range calculation unit 15 integrates the second ranges of each of the groups for each of the candidate vectors. The integrated second range indicates the second range of the candidate vector.

For example, the integration of the second range may be performed using weighting on each group, and is expressed by the following formulas (23) to (24).

$$[ Mathematical formula 23 ]$$

$${u}_{i}^{Integ} ← \frac{1}{d} {\sum }_{g = 1}^{G} {d}_{g} {u}_{i , g}^{Group} \qquad ( 23 )$$

In formula (23), u_(i, g)\hat{ }Integ represents an upper bound of the integrated second range. d_g indicates a weight of the group g. As shown in formula (23), the weighted average of the upper bound u_(i, g)\hat{ }Group of the second range of each group is calculated as the upper bound u_(i, g)\hat{ }Integ of the integrated second range.

$$[ Mathematical formula 24 ]$$

$${l}_{i}^{Integ} ← \frac{1}{d} {\sum }_{g = 1}^{G} {d}_{g} {l}_{i , g}^{Group} \qquad ( 24 )$$

In formula (24), 1_(i, g)\hat{ }Integ represents the lower bound of the integrated second range. d_g indicates a weight of the group g. As shown in formula (24), the weighted average of the lower bound 1_(i, g)\hat{ }Group of the second range of each group is calculated as the lower Bound 1_(i, g)\hat{ }Integ of the integrated second range.

The integration of the second ranges is not limited to the formulas (23) to (24), and may be performed based on other formulas.

Step S110 is an example of the candidate selection processing. In step S110, the candidate selection unit 13 selects one or more candidate vectors from the plurality of candidate vectors (i.e., the candidate list) based on the integrated second range. For example, the candidate selection unit 13 may select, with the lower bound of the candidate vector in which lower bound of the second range is the highest as a threshold value, one or more candidate vectors in which the upper bound of the second range is equal to or greater than the threshold value. In addition, the candidate selection unit 13 updates the candidate list by excluding the candidate vector that has not been selected from the candidate list.

In step S111, the identification unit 14 determines whether the number of the selected candidate vectors (i.e., the candidate vectors remaining in the updated candidate list) is equal to or less than a threshold value. The threshold value indicates an upper limit of the number of similar vectors to be identified.

In a case where it is determined as No in step S110, the control unit 110 adds 1 to the number of times of sampling d_used and repeats the processing from step S106. As a result, the third range is updated based on the newly sampled element (S106 to S107). In addition, the second range is updated based on the first range and the updated third range, and the candidate list is updated based on the updated second range (steps S108 to S110).

In a case where it is determined as Yes in step S110, the next step S112 is executed. Step S112 is an example of the identification processing. In step S112, the identification unit 14 outputs the selected candidate vector (i.e., the candidate vector remaining in the candidate list) as a similar vector.

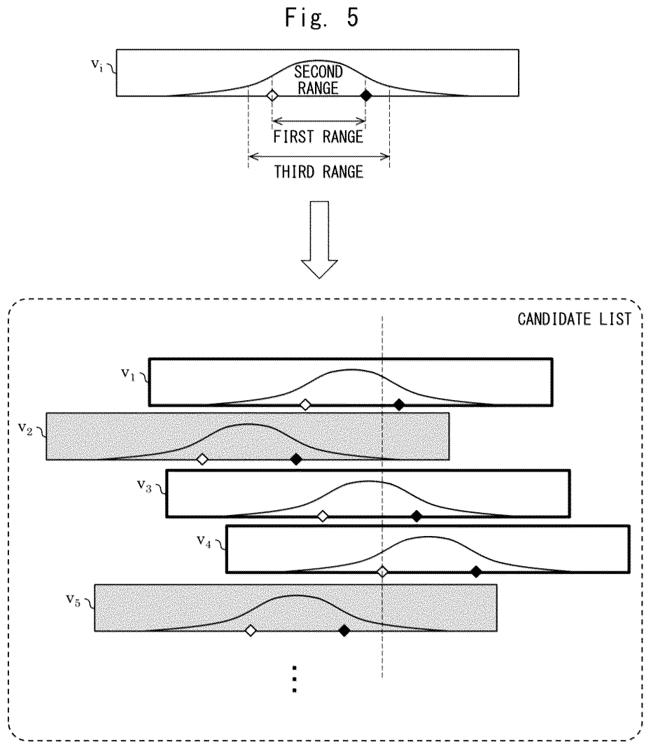

FIG. 5 is a diagram schematically illustrating narrowing down of candidate vector by the information processing method S1A.

In FIG. 5, it is assumed that the number of groups is one (i.e., it is not divided). As illustrated in FIG. 5, for each candidate vector v_i, a first range and a third range are calculated, and a second range in which the first range and the third range overlap is calculated. As in the example of FIG. 5, in a case where the first range is included in the third range, the first range that is the overlapping range is directly applied as the second range. In FIG. 5, a white diamond indicates a lower bound of the second range, and a black diamond indicates an upper bound of the second range. As illustrated in FIG. 5, since the lower bound of the second range of the candidate vector v_4 is the highest in the candidate list, it becomes the threshold value. The candidate vectors v_2 and v_5 have the upper bound of the second range smaller than the threshold value, and thus are excluded from the candidate list. Therefore, the candidate list is updated while leaving the candidate vectors v_1, v_3, and v_4.

Here, the first range is calculated at least once in advance, and the third range is calculated and updated each time an element is sampled. The third range is relatively wider the smaller the number of times of sampling of the element. Therefore, as a comparative example, in a method of updating the candidate list only by the third range, for example, BanditMIPS, the candidate list cannot be effectively narrowed down until the number of times of sampling becomes equal to or greater than a certain level. In the information processing device 1A, since the first range and the third range are based on the overlapping second range, it is possible to narrow down the candidate vector as illustrated in FIG. 5 from the early stage at which the number of times of sampling is small. As a result, the calculation cost until the similar vector is identified can be greatly reduced as compared with the comparative example.

### (Effects of Information Processing Device 1A)

As described above, in the information processing device 1A, the single variable term calculation unit 11 adopts a configuration including the first single variable term calculation unit 111 for calculating in advance the first single variable term that depends on each candidate vector and does not depend on the input vector among the single variable terms, and the second single variable term calculation unit 112 for calculating the second single variable term that depends on the input vector and does not depend on each candidate vector among the single variable terms according to the input of the input vector. Therefore, according to the information processing device 1A, in addition to the effects obtained by the information processing device 1, an effect of contributing to a reduction in calculation cost can be obtained by calculating in advance the first single variable term that can be commonly used for any input vector. In addition, since the second single variable term can be calculated in a time not dependent on the number of candidate vectors according to the input of the input vector, an effect of contributing to a reduction in calculation cost can be obtained.

Furthermore, the information processing device 1A adopts a configuration including a second range calculation unit 15 for calculating, for each of the plurality of candidate vectors, at least some of the multivariable terms that depend on both the candidate vector and the input vector among the plurality of terms, and calculating a second range that the similarity can take based on the at least some of the multivariable terms and the first range, in which the candidate selection unit 13 selects one or more candidate vectors based on the second range. Therefore, according to the information processing device 1A, in addition to the effects obtained by the information processing device 1, a range for effectively narrowing down the candidate vector can be accurately obtained.

Furthermore, in the information processing device 1A, the second range calculation unit 15 adopts a configuration of calculating at least some of the multivariable terms based on elements sampled from the candidate vector and the input vector for each of the plurality of candidate vectors, and updating at least some of the multivariable terms further based on elements newly sampled from the candidate vector and the input vector for each of the selected one or more candidate vectors, thereby updating the second range. Therefore, according to the information processing device 1A, in addition to the effect obtained by the information processing device 1, an effect that the candidate vector can be narrowed down accurately by the second range on which the information derived from the multivariable term is more reflected as the number of times of sampling increases while effectively narrowing down the candidate vector by the second range on which the first range is reflected from the early stage at which the number of times of sampling is small.

### Application Example

First to fifth application examples using the above-described information processing devices 1 and 1A will be described.

### First Application Example

For example, the information processing devices 1 and 1A can be applied to, for example, an application of finding a case in which the marginal contribution degrees in prediction by a machine learning model are similar. The marginal contribution degree indicates a degree of contribution of each feature value on the prediction in a case where the machine learning model outputs the prediction. In addition, a vector in which the marginal contribution degrees of each of the feature values are arranged as elements is referred to as a marginal contribution degree vector. A case having a marginal contribution degree vector similar to the marginal contribution degree vector in a certain prediction can be said to be a case where similar prediction is performed based on similar feature values with respect to the certain prediction. Therefore, finding a similar marginal contribution degree vector for a certain marginal contribution degree vector is useful for data analysis. For example, for a case with a high failure probability, finding a past case in which the same factor contributed to the failure is useful for analyzing the failure cause.

In the present application example, a certain marginal contribution degree vector is used as an input vector, and each of the other marginal contribution degree vectors is used as a candidate vector. As a result, according to the present application example, a similar marginal contribution degree vector for a certain marginal contribution degree vector can be identified at high speed.

Furthermore, in a case where the information processing device 1A is used, it is effective to divide the marginal contribution degree vectors into a plurality of groups by the division unit 16. Here, the contribution degree of the feature value corresponding to the same variable among the plurality of feature values tends to have close values. Therefore, a narrower range can be calculated as the first range of each group by grouping elements corresponding to the same variable among the elements of the marginal contribution degree vector into one group. As a result, according to the present application example, the candidate vectors can be narrowed down more effectively, and an effect of further contributing to a reduction of the calculation cost can be expected.

For example, if a characteristic function v(S) for measuring the value of the set S is given, a marginal contribution degree M(S, i) representing the contribution of a certain element i to the set S is defined as the following formula (25).

$$[ Mathematical formula 25 ]$$

$$M ( S , i ) = v ( S ⋃ \{ i \} ) - v ( S ) \qquad ( 25 )$$

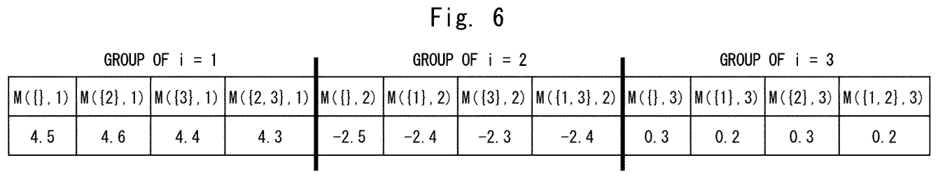

Here, a vector in which the marginal contribution degrees M(S, i) are arranged for a possible combination of S and i is defined as a marginal contribution degree vector. For example, if a set of elements is {1, 2, 3}, the marginal contribution degree vector is as illustrated in FIG. 6. FIG. 6 is a diagram schematically illustrating an example of a marginal contribution degree vector. As illustrated in FIG. 6, the elements of the marginal contribution degree vector can be divided into a group of i=1, a group of i=2, and a group of i=3. As a result, elements having similar distributions can be collected, and a narrower first range can be calculated for each group. As a result, according to the present application example, a case having a marginal contribution degree vector similar to a certain marginal contribution degree vector can be identified at a higher speed.

### Second Application Example

The information processing devices 1 and 1A can be applied to, for example, document search. For example, in the present application example, the feature value vector indicating a search query input by the user is set as the input vector, and the feature vector indicating each document is set as the candidate vector. As a result, according to the present application example, a document similar to the search query input by the user can be identified at high speed.

### Third Application Example

The information processing devices 1 and 1A can be applied to, for example, an application of generating an answer to a user's question using a large-scale language model. For example, in the present application example, a feature value vector indicating a question input by the user is used as the input vector, and a feature value vector indicating each document that can be referred to by the large-scale language model to generate an answer is used as the candidate vector. As a result, according to the present application example, a document related to a question input by the user can be identified at a high speed, and as a result, an answer can be generated at a high speed with reference to the identified document.

### Fourth Application Example

The information processing devices 1 and 1A can be applied to, for example, similar case search. For example, in the present application example, a feature value vector indicating a certain case is used as the input vector, and a feature value vector indicating each of the other cases is used as the candidate vector. As a result, according to the present application example, another case similar to a certain case can be identified at high speed. For example, knowledge can be obtained by identifying similar cases in machine learning.

### Fifth Application Example

The information processing devices 1 and 1A can be applied to, for example, product recommendation. The product recommendation is to recommend a similar product to a user who has browsed a certain product. For example, in the present application example, the feature value vector of the product browsed by the user is set as the input vector, and the feature force vector of each of the other products is set as the candidate vector. According to the present application example, a product to be recommended to the user can be identified at high speed.

### [Exemplary Implementation by Software]

Some or all of the functions of the information processing devices 1 and 1A (which will also be referred to as “each of the above devices” hereinafter) may be implemented by hardware such as an integrated circuit (IC chip), or may be implemented by software.

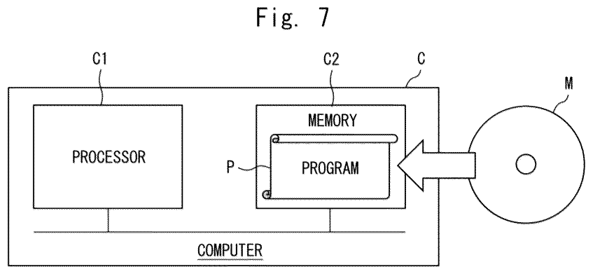

In the latter case, each of the above devices is implemented by, for example, a computer that executes commands of a program, that is software for implementing each function. An example of such a computer (hereinafter, referred to as a computer C) is illustrated in FIG. 7. FIG. 7 is a block diagram illustrating a hardware configuration of the computer C functioning as each of the above devices.

The computer C includes at least one processor C1 and at least one memory C2. A program P for causing the computer C to operate as each of the above devices is recorded in the memory C2. In the computer C, the processor C1 reads the program P from the memory C2 and executes it, thereby implementing the functions of each of the above devices.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof can be used. As the memory C2, for example, a flash memory, a Hard Disk Drive (HDD), a Solid State Drive (SSD), or a combination thereof can be used.

The computer C may further include a Random Access Memory (RAM) for loading the program P at the time of execution and temporarily storing various types of data. Furthermore, the computer C may further include a communication interface for transmitting and receiving data to and from another device. In addition, the computer C may further include an input/output interface for connecting input/output devices such as a keyboard, a mouse, a display, and a printer.

Furthermore, the program P can be recorded in a non-transitory tangible recording medium M readable by the computer C. As such a recording medium M, for example, a tape, a disk, a card, a semiconductor memory, or a programmable logic circuit may be used.

The computer C may acquire the program P via such a recording medium M. Furthermore, the program P may be transmitted via a transmission medium. As such a transmission medium, for example, a communication network or a broadcast wave may be used. The computer C can also acquire the program P via such a transmission medium.

The functions of each of the above devices may be implemented by a single processor provided in a single computer, may be implemented, in cooperation, by a plurality of processors provided in a single computer, or may be implemented, in cooperation, by a plurality of processors provided in each of a plurality of computers. The program for causing each of the above devices to implement the functions described above may be stored in a single memory provided in a single computer, may be stored in a distributed manner in a plurality of memories provided in a single computer, or may be stored in a distributed manner in a plurality of memories provided in each of a plurality of computers.

### [Supplementary Note Matter A]

The present disclosure includes a technique described in each of the Supplementary Notes below. However, the present disclosure is not limited to the techniques described in the following supplementary notes, and various modifications can be made within the scope described in the claims.

### (Supplementary Note A1)

An information processing device including,
a single variable term calculation means for calculating a single variable term that, among a plurality of terms for calculating a similarity with an input vector for each of a plurality of candidate vectors that are candidates for a similar vector similar to the input vector, depends on either one of the candidate vector and the input vector and does not depend on the other one,
a first range calculation means for calculating, for each of the plurality of candidate vectors, a first range that the similarity can take based on the single variable term,
a candidate selection means for selecting one or more candidate vectors from the plurality of candidate vectors based on the first range, and
an identification means for identifying the similar vector from the selected one or more candidate vectors.

### (Supplementary Note A2)

The information processing device according to supplementary note A1, in which
the single variable term calculation means includes,
a first single variable term calculation means for calculating in advance a first single variable term that depends on each candidate vector and does not depend on the input vector among the single variable terms, and
a second single variable term calculation means for calculating a second single variable term that depends on the input vector and does not depend on each candidate vector among the single variable terms according to an input of the input vector.

### (Supplementary Note A3)

The information processing device according to supplementary note A1 or A2, further including,
a second range calculation means for calculating, for each of the plurality of candidate vectors, at least some of multivariable terms that depends on both the candidate vector and the input vector among the plurality of terms, and calculating a second range that the similarity can take based on the at least some of the multivariable terms and the first range,
in which the candidate selection means selects the one or more candidate vectors based on the second range.

### (Supplementary Note A4)

The information processing device according to supplementary note A3, in which
the second range calculation means,
calculates, for each of the plurality of candidate vectors, the second range by calculating at least some of the multivariable terms based on elements sampled from the candidate vector and the input vector, and
updates, for each of the selected one or more candidate vectors, the second range by updating at least some of the multivariable terms further based on elements newly sampled from the candidate vector and the input vector.

### (Supplementary Note A5)

The information processing device according to any one of supplementary notes A1 to A4, further including,
a division means for dividing elements of each candidate vector and elements of the input vector into a plurality of groups, in which
the single variable term calculation means calculates the single variable term for each group of each candidate vector and each group of the input vector,
the first range calculation means calculates the first range based on the single variable term for each group of each candidate vector, and
the candidate selection means selects the one or more candidate vectors based on the first range for each group of each candidate vector.

### [Supplementary Note Matter B]

The present disclosure includes a technique described in each of the Supplementary Notes below. However, the present disclosure is not limited to the techniques described in the following supplementary notes, and various modifications can be made within the scope described in the claims.

### (Supplementary Note B1)

An information processing method including,
single variable term calculation processing in which at least one processor calculates a single variable term that, among a plurality of terms for calculating a similarity with an input vector for each of a plurality of candidate vectors that are candidates for a similar vector similar to the input vector, depends on either one of the candidate vector and the input vector and does not depend on the other one,
first range calculation processing in which the at least one processor calculates, for each of the plurality of candidate vectors, a first range that the similarity can take based on the single variable term,
candidate selection processing in which the at least one processor selects one or more candidate vectors from the plurality of candidate vectors based on the first range, and identification processing in which the at least one processor identifies the similar vector from the selected one or more candidate vectors.

### (Supplementary Note B2)

The information processing method according to supplementary note B1, in which
the single variable term calculation processing includes,
first single variable term calculation processing in which the at least one processor calculates in advance a first single variable term that depends on each candidate vector and does not depend on the input vector among the single variable terms, and
second single variable term calculation processing in which the at least one processor calculates a second single variable term that depends on the input vector and does not depend on each candidate vector among the single variable terms according to an input of the input vector.

### (Supplementary Note B3)

The information processing method according to supplementary note B1 or B2, further including,
second range calculation processing in which the at least one processor calculates, for each of the plurality of candidate vectors, at least some of multivariable terms that depend on both the candidate vector and the input vector among the plurality of terms, and calculates a second range that the similarity can take based on the at least some multivariable terms and the first range,
in which in the candidate selection processing, the at least one processor selects the one or more candidate vectors based on the second range.

### (Supplementary Note B4)

The information processing method according to supplementary note B3, in which
in the second range calculation processing, the at least one processor
calculates, for each of the plurality of candidate vectors, the second range by calculating at least some of the multivariable terms based on elements sampled from the candidate vector and the input vector, and
updates, for each of the selected one or more candidate vectors, the second range by updating at least some of the multivariable terms further based on elements newly sampled from the candidate vector and the input vector.

### (Supplementary Note B5)

The information processing method according to any one of supplementary notes B1 to B4, further including
division processing in which the at least one processor divides elements of each candidate vector and elements of the input vector into a plurality of groups, in which
in the single variable term calculation processing, the at least one processor calculates the single variable term for each group of each candidate vector and each group of the input vector,
in the first range calculation processing, the at least one processor calculates the first range based on the single variable term for each group of each candidate vector, and
in the candidate selection processing, the at least one processor selects the one or more candidate vectors based on the first range for each group of the candidate vector.

### [Supplementary Note Matter C]

The present disclosure includes a technique described in each of the Supplementary Notes below. However, the present disclosure is not limited to the techniques described in the following supplementary notes, and various modifications can be made within the scope described in the claims.

### (Supplementary Note C1)

An information processing program for causing a computer to function as an information processing device, the program causing the computer to function as,
a single variable term calculation means for calculating a single variable term that, among a plurality of terms for calculating a similarity with an input vector for each of a plurality of candidate vectors that are candidates for a similar vector similar to the input vector, depends on either one of the candidate vector and the input vector and does not depend on the other one,
a first range calculation means for calculating, for each of the plurality of candidate vectors, a first range that the similarity can take based on the single variable term,
a candidate selection means for selecting one or more candidate vectors from the plurality of candidate vectors based on the first range, and
an identification means for identifying the similar vector from the selected one or more candidate vectors.

### (Supplementary Note C2)

The information processing program according to supplementary note C1, in which
the single variable term calculation means includes,
a first single variable term calculation means for calculating in advance a first single variable term that depends on each candidate vector and does not depend on the input vector among the single variable terms, and
a second single variable term calculation means for calculating a second single variable term that depends on the input vector and does not depend on each candidate vector among the single variable terms according to an input of the input vector.

### (Supplementary Note C3)

The information processing program according to supplementary note C1 or C2, further causing the computer to function as,
a second range calculation means for calculating, for each of the plurality of candidate vectors, at least some of multivariable terms that depend on both the candidate vector and the input vector among the plurality of terms, and calculating a second range that the similarity can take based on the at least some of the multivariable terms and the first range,
in which the candidate selection means selects the one or more candidate vectors based on the second range.

### (Supplementary Note C4)

The information processing program according to supplementary note C3, in which
the second range calculation means,
calculates, for each of the plurality of candidate vectors, the second range by calculating at least some of the multivariable terms based on elements sampled from the candidate vector and the input vector, and
updates, for each of the selected one or more candidate vectors, the second range by updating at least some of the multivariable terms further based on elements newly sampled from the candidate vector and the input vector.

### (Supplementary Note C5)

The information processing program according to any one of supplementary notes C1 to C4, further causing the computer to function as,
a division means for dividing elements of each candidate vector and elements of the input vector into a plurality of groups, in which
the single variable term calculation means calculates the single variable term for each group of each candidate vector and each group of the input vector,
the first range calculation means calculates the first range based on the single variable term for each group of each candidate vector, and
the candidate selection means selects the one or more candidate vectors based on the first range for each group of each candidate vector.

### [Supplementary Note Matter D]

The present disclosure includes a technique described in each of the Supplementary Notes below. However, the present disclosure is not limited to the techniques described in the following supplementary notes, and various modifications can be made within the scope described in the claims.

### (Supplementary Note D1)

An information processing device including at least one processor, in which the at least one processor executes, single variable term calculation processing of calculating a
single variable term that, among a plurality of terms for calculating a similarity with an input vector for each of a plurality of candidate vectors that are candidates for a similar vector similar to the input vector, depends on either one of the candidate vector and the input vector and does not depend on the other one,
first range calculation processing of calculating, for each of the plurality of candidate vectors, a first range that the similarity can take based on the single variable term,
candidate selection processing of selecting one or more candidate vectors from the plurality of candidate vectors based on the first range, and
identification processing of identifying the similar vector from the selected one or more candidate vectors.

The information processing device may further include a memory. Furthermore, the memory may store a program for causing the at least one processor to execute each processing.

### (Supplementary Note D2)

The information processing device according to supplementary note D1, in which
in the single variable term calculation processing, the at least one processor executes,
first single variable term calculation processing of calculating in advance a first single variable term that depends on each candidate vector and does not depend on the input vector among the single variable terms, and
second single variable term calculation processing of calculating a second single variable term that depends on the input vector and does not depend on each candidate vector among the single variable terms according to an input of the input vector.

### (Supplementary Note D3)

The information processing device according to supplementary note D1 or D2, in which the at least one processor further executes,
second range calculation processing of calculating, for each of the plurality of candidate vectors, at least some of multivariable terms that depend on both the candidate vector and the input vector among the plurality of terms, and calculating a second range that the similarity can take based on the at least some multivariable terms and the first range, and
in the candidate selection processing, the at least one processor selects the one or more candidate vectors based on the second range.

### (Supplementary Note D4)

The information processing device according to supplementary note D3, in which
in the second range calculation processing, the at least one processor
calculates, for each of the plurality of candidate vectors, the second range by calculating at least some of the multivariable terms based on elements sampled from the candidate vector and the input vector, and updates, for each of the selected one or more candidate vectors,
the second range by updating at least some of the multivariable terms further based on elements newly sampled from the candidate vector and the input vector.

### (Supplementary Note D5)

The information processing device according to any one of supplementary notes D1 to D4, in which the at least one processor further executes
division processing of dividing elements of each candidate vector and elements of the input vector into a plurality of groups, in which
in the single variable term calculation processing, the at least one processor calculates the single variable term for each group of each candidate vector and each group of the input vector,
in the first range calculation processing, the at least one processor calculates the first range based on the single variable term for each group of each candidate vector, and
in the candidate selection processing, the at least one processor selects the one or more candidate vectors based on the first range for each group of the candidate vector.

### [Supplementary Note Matter E]

The present disclosure includes a technique described in each of the Supplementary Notes below. However, the present disclosure is not limited to the techniques described in the following supplementary notes, and various modifications can be made within the scope described in the claims.

### (Supplementary Note E1)

A non-transitory recording medium recorded with a program for causing a computer to function as an information processing device, the program causing the computer to execute,
single variable term calculation processing of calculating a single variable term that, among a plurality of terms for calculating a similarity with an input vector for each of a plurality of candidate vectors that are candidates for a similar vector similar to the input vector, depends on either one of the candidate vector and the input vector and does not depend on the other one,
first range calculation processing of calculating, for each of the plurality of candidate vectors, a first range that the similarity can take based on the single variable term,
candidate selection processing of selecting one or more candidate vectors from the plurality of candidate vectors based on the first range, and
identification processing of identifying the similar vector from the selected one or more candidate vectors.

1. An information processing device comprising:
at least one computer-readable medium storing computer-executable instructions;
at least one processor communicatively coupled to the at least one computer-readable medium and configured to execute the computer executable instructions, the execution carrying out operations including:
calculating a single variable term that, among a plurality of terms for calculating a similarity with an input vector for each of a plurality of candidate vectors that are candidates for a similar vector similar to the input vector, depends on either one of the candidate vector and the input vector and does not depend on the other one;
calculating, for each of the plurality of candidate vectors, a first range that the similarity can take based on the single variable term;
selecting one or more candidate vectors from the plurality of candidate vectors based on the first range; and
identifying the similar vector from the selected one or more candidate vectors.

2. The information processing device according to claim 1, wherein
the operations further include:
calculating in advance a first single variable term that depends on each candidate vector and does not depend on the input vector among the single variable terms; and
calculating a second single variable term that depends on the input vector and does not depend on each candidate vector among the single variable terms according to an input of the input vector.

3. The information processing device according to claim 1, wherein the operations further include:
calculating, for each of the plurality of candidate vectors, at least some of multivariable terms that depend on both the candidate vector and the input vector among the plurality of terms, and calculating a second range that the similarity can take based on the at least some of the multivariable terms and the first range,
wherein the one or more candidate vectors is selected based on the second range.

4. The information processing device according to claim 3, wherein in the second range calculation, for each of the plurality of candidate vectors, the second range is calculated by calculating at least some of the multivariable terms based on elements sampled from the candidate vector and the input vector; and
for each of the selected one or more candidate vectors, the second range is updated by updating at least some of the multivariable terms further based on elements newly sampled from the candidate vector and the input vector.

5. The information processing device according to claim 1, wherein
the operations further include:
dividing elements of each candidate vector and elements of the input vector into a plurality of groups, wherein
the single variable term is calculated for each group of each candidate vector and each group of the input vector;
the first range is calculated based on the single variable term for each group of each candidate vector; and
the one or more candidate vectors is selected based on the first range for each group of each candidate vector.

6. An information processing method comprising:
single variable term calculation processing in which at least one processor calculates a single variable term that, among a plurality of terms for calculating a similarity with an input vector for each of a plurality of candidate vectors that are candidates for a similar vector similar to the input vector, depends on either one of the candidate vector and the input vector and does not depend on the other one;
first range calculation processing in which the at least one processor calculates, for each of the plurality of candidate vectors, a first range that the similarity can take based on the single variable term;
candidate selection processing in which the at least one processor selects one or more candidate vectors from the plurality of candidate vectors based on the first range; and
identification processing in which the at least one processor identifies the similar vector from the selected one or more candidate vectors.

7. A non-transitory computer readable medium storing a program that causes a computer to execute information processing comprising:
single variable term calculation processing in which at least one processor calculates a single variable term that, among a plurality of terms for calculating a similarity with an input vector for each of a plurality of candidate vectors that are candidates for a similar vector similar to the input vector, depends on either one of the candidate vector and the input vector and does not depend on the other one;
first range calculation processing in which the at least one processor calculates, for each of the plurality of candidate vectors, a first range that the similarity can take based on the single variable term;
candidate selection processing in which the at least one processor selects one or more candidate vectors from the plurality of candidate vectors based on the first range; and
identification processing in which the at least one processor identifies the similar vector from the selected one or more candidate vectors.
